(19) United States
(12) Patent Application Publication
(10) Pub. No.: US 2024/0216878 A1
(43) Pub. Date: Jul. 4, 2024

(54) METHOD OF PRODUCING SLURRY

(71) Applicant: Prime Planet Energy & Solutions, Inc., Tokyo (JP)

(72) Inventors: Daisuke IKEDA, Kakogawa-shi (JP); Kazuhiro MAEDA, Himeji-shi (JP); Kentaro TAKAHASHI, Kasai-shi (JP)

(21) Appl. No.: 18/503,179

(22) Filed: Nov. 7, 2023

(30) Foreign Application Priority Data
Dec. 28, 2022 (JP) 2022-211230

(51) Int. Cl. B01F 23/50; C09D 7/20; C09D 7/61; C09D 7/80; C09D 127/12; H01M 10/42; H01M 50/586

(52) U.S. Cl. CPC B01F 23/511; B01F 23/565; C09D 7/20; C09D 7/61; C09D 7/80; C09D 127/12; H01M 10/4235; H01M 50/586; B01F 2215/0481; B01F 2215/0495; C08K 2003/2227

(57) ABSTRACT

A slurry intended for forming a protective layer for a non-aqueous electrolyte secondary battery includes an inorganic oxide filler, a binding material, and a solvent. A method of producing the slurry comprises a step that involves obtaining a dispersion by dispersing the inorganic oxide filler in the solvent, and a step that involves mixing the dispersion with the binding material and stirring.

### CROSS REFERENCE TO RELATED APPLICATIONS

This nonprovisional application is based on Japanese Patent Application No. 2022-211230 filed on Dec. 28, 2022, with the Japan Patent Office, the entire contents of which are hereby incorporated by reference.

### BACKGROUND OF THE INVENTION

### Field of the Invention

The present invention relates to a method of producing a slurry to be used for forming a protective layer for a non-aqueous electrolyte secondary battery.

### Description of the Background Art

It is known that in a non-aqueous electrolyte secondary battery, a protective layer is formed on an electrode and the like. For forming a protective layer, a coating material that is obtained by mixing an inorganic oxide filler, a binding material, and a solvent is used (see Japanese Patent Laying-Open No. 2008-016311, for example).

### SUMMARY OF THE INVENTION

When lumps (aggregated matter) are present in the coating material that is to be used for forming a protective layer, defects can occur in the resulting coating film, potentially leading to defects in the resulting defective protective layer. Lumps can be reduced and a coating material with a uniformly dispersed filler can be obtained by taking enough time for, for example, mixing the components of the coating material and sufficiently stirring, but this can decrease productivity. Because of this, there is a need for efficiently preparing a coating material with reduced lumps.

An object of the present disclosure is to provide a method of producing a slurry intended for forming a protective layer for a non-aqueous electrolyte secondary battery where the method is capable of efficiently producing the slurry with reduced lumps.
[1] A method of producing a slurry intended for forming a protective layer for a non-aqueous electrolyte secondary battery, wherein
the slurry includes an inorganic oxide filler, a binding material, and a solvent, and
the method comprises:
   a step (S1) that involves obtaining a dispersion by dispersing the inorganic oxide filler in the solvent; and
   a step (S2) that involves mixing the dispersion with the binding material and stirring.
[2] The method of producing a slurry according to [1], wherein the step (S2) includes:
a step (S2a) that involves obtaining a first mixed liquid by mixing the dispersion with a part of a total amount of the binding material to be included in the slurry and stirring; and
a step (S2b) that involves mixing the first mixed liquid with a part or whole of a reminder of the total amount of the binding material and stirring.
[3] The method of producing a slurry according to [2], wherein the step (S2b) repeats a process of mixing the first mixed liquid with a part of the reminder of the total amount of the binding material and stirring to obtain a second mixed liquid, two or more times.
[4] The method of producing a slurry according to [2] or [3], wherein
the step (S2) is carried out using a stirrer equipped with a stirring blade, and
a number of revolutions of the stirring blade in the step (S2) is from 1500 rpm to 8000 rpm.
[5] The method of producing a slurry according to any one of [1] to [4], wherein the inorganic oxide filler is one or more types selected from the group consisting of alumina filler, magnesia filler, silica filler, zirconia filler, and titania filler.
[6] The method of producing a slurry according to any one of [1] to [5], wherein the binding material is powder of a polymer compound.
[7] The method of producing a slurry according to any one of [1] to [6], wherein the binding material is polyvinylidene difluoride (PVdF).
[8] The method of producing a slurry according to any one of [1] to [7], wherein a viscosity of the slurry at a temperature from 10 to 40° C. is from 500 mPa·s to 1500 mPa·s.
[9] The method of producing a slurry according to any one of [1] to [8], wherein a solid content of the slurry is from 10 weight % to 40 weight %.
[10] The method of producing a slurry according to any one of [1] to [9], wherein the slurry further includes a conductive agent.
[11] The method of producing a slurry according to any one of [1] to [10], wherein the solvent is a non-aqueous solvent.

The foregoing and other objects, features, aspects and advantages of the present invention, when taken in conjunction with the accompanying drawings will become more apparent from the following detailed description of the present invention.

### BRIEF DESCRIPTION OF THE DRAWINGS

FIG. 1 is a flowchart illustrating a method of producing a slurry according to an embodiment of the present disclosure.

FIG. 2 is a flowchart illustrating a method of producing a slurry according to another embodiment of the present disclosure.

FIG. 3 is a flowchart illustrating a method of producing a slurry of Comparative Example.

### DESCRIPTION OF THE PREFERRED EMBODIMENTS

### (Method of Producing Slurry)

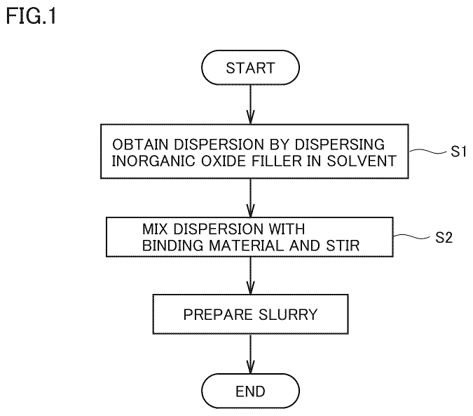

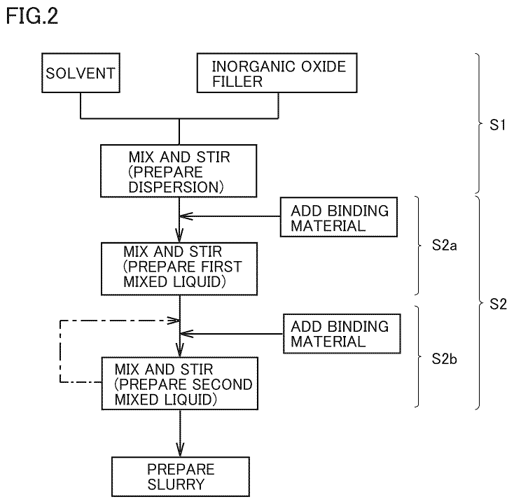

Each of FIG. 1 and FIG. 2 is a flowchart illustrating a method of producing a slurry according to an embodiment of the present disclosure. The method of producing a slurry according to the present embodiment is a method of producing a slurry intended for forming a protective layer for a non-aqueous electrolyte secondary battery.

The protective layer can be provided to an electrode assembly such as a positive electrode plate and a negative electrode plate included in a non-aqueous electrolyte secondary battery. For instance, the protective layer may be formed in a position adjacent to a positive electrode active material layer in a plan view of the positive electrode plate, or may be formed in a position adjacent to a negative electrode active material layer in a plan view of the negative electrode plate, or may be formed on the positive electrode active material layer and/or on the negative electrode active material layer to cover the surface of the positive electrode active material layer and/or the negative electrode active material layer. Usually, the protective layer provided to the positive electrode plate has an electrical conductivity that is lower than that of a positive electrode current collector and that of the positive electrode active material layer. The protective layer provided to the negative electrode plate has an electrical conductivity that is lower than that of a negative electrode current collector and that of the negative electrode active material layer. When the protective layer is provided, internal short circuits that can occur inside the battery due to separator breakage and the like can be reduced, and the heat resistance of the positive electrode plate and the negative electrode plate can be enhanced.

The slurry includes an inorganic oxide filler, a binding material, and a solvent. The slurry may further include a conductive agent.

The inorganic oxide filler may be a metal oxide filler. Examples of the inorganic oxide filler include one or more types selected from the group consisting of alumina (Al₂O₃) filler, magnesia (MgO) filler, silica (SiO₂) filler, zirconia (ZrO₂) filler, and titania (TiO₂) filler.

The binding material is preferably a polymer compound, more preferably powder of a polymer compound. Examples of the polymer compound include one or more types selected from the group consisting of polyvinylidene difluoride (PVdF), polytetrafluoroethylene (PTFE), polyimide (PI), and polyamide-imide (PAI). The polymer compound is preferably PVdF.

The solvent is preferably a non-aqueous solvent. Examples of the solvent include N-methyl-2-pyrrolidone (NMP).

Examples of the conductive agent include one or more types selected from the group consisting of carbon black (such as acetylene black, Ketjenblack), graphite (such as flake-shaped graphite), carbon nanotubes, carbon nanohorns, graphene, and fullerene.

The viscosity of the slurry at a temperature from 10 to 40° C. (25±15° C.) is preferably from 500 mPa·s to 1500 mPa-s, optionally from 700 mPa·s to 1400 mPa·s, optionally from 800 mPa·s to 1300 mPa·s. The viscosity of the slurry is, as described below in the Examples section, a value measured with a spiral viscometer at a temperature of 25° C. and a number of revolutions of 40 rpm. As the method for producing a slurry having the above-mentioned viscosity, the method of producing a slurry according to the present embodiment is suitably adopted. The method of producing a slurry according to the present embodiment is differentiated from a method of producing a positive electrode slurry or a negative electrode slurry because the slurry according to the present embodiment does not include a positive electrode active material or a negative electrode active material, and, in addition, it is also differentiated in terms of the viscosity of the slurry. For example, the viscosity of a positive electrode slurry intended for use for forming a positive electrode active material layer is higher than the viscosity of the slurry according to the present embodiment.

The solid content of the slurry relative to the total amount of the slurry is preferably from 10 weight % to 40 weight %, more preferably from 15 weight % to 30 weight %, further preferably from 15 weight % to 25 weight %. The solid content of the slurry is the ratio of the weight of solid matter (the component other than the solvent) to the total weight of the slurry. As the method for producing a slurry having the above-mentioned solid content, the method of producing a slurry according to the present embodiment is suitably adopted. The solid content of a positive electrode slurry intended for use for forming a positive electrode active material layer is higher than the above-mentioned solid content of the slurry according to the present embodiment, so also in this point, the method of producing a slurry according to the present embodiment is differentiated from a method of producing a positive electrode slurry.

The content of the inorganic oxide filler included in the slurry relative to the total amount of the solid matter in the slurry may be from 40 weight % to 95 weight %, or may be from 50 weight % to 90 weight %, or may be from 60 weight % to 85 weight %. The content of the binding material included in the slurry relative to the total amount of the solid matter in the slurry may be from 5 weight % to 50 weight %, or may be from 10 weight % to 35 weight %. The content of the conductive agent included in the slurry relative to the total amount of the solid matter in the slurry may be from 0 weight % to 10 weight %, or may be from 0.05 weight % to 5 weight %.

The method of producing a slurry according to the present embodiment includes, as illustrated in FIG. 1 and FIG. 2:
a step (S1) that involves obtaining a dispersion by dispersing the inorganic oxide filler in the solvent; and
a step (S2) that involves mixing the dispersion with the binding material and stirring. In the method of producing a slurry, the slurry is prepared through the step (S1) and the step (S2).

A binding material tends to serve as nuclei for lumps (aggregated matter) that can be formed in a slurry; so, generally, a binding material and a solvent are mixed first to form a binding material solution, and then inorganic oxide particles are added to the resulting binding material solution to prepare a slurry. In contrast to this, in the method of producing a slurry according to the present embodiment, the inorganic oxide filler is dispersed in the solvent, and, to the resulting dispersion, the binding material is added and mixed. The viscosity of the solvent is lower than that of the binding material solution. Because of this, in the step (S1), the inorganic oxide filler is easily dispersed in the solvent and, thereby, a dispersion with excellent dispersibility of the inorganic oxide filler can be obtained efficiently. Subsequently, by implementing an easy and simple method involving adding the binding material to the dispersion and stirring (step (S2)), the slurry may be prepared in a relatively short time with reduced lumps in the slurry. As described above, when the viscosity of the slurry is within the above-mentioned range and/or when the solid content of the slurry is within the above-mentioned range, the method of producing a slurry according to the present embodiment can be particularly suitably adopted.

For instance, in the step (S1), the inorganic oxide filler is added to the solvent to obtain a mixture of the solvent and the inorganic oxide filler, followed by stirring the resulting mixture, and thereby a dispersion may be obtained. Because the viscosity of the solvent is low as described above, the inorganic oxide filler is easily dispersed. In the step (S1), a dispersion with high dispersibility of the inorganic oxide filler can be obtained. The inorganic oxide filler may be added to the solvent all at once, or may be added to the solvent in two or more portions. In the step (S1), from the viewpoint of enhancing the slurry productivity, it is preferable to add the inorganic oxide filler all at once to the solvent and stir. In the case when the inorganic oxide filler is added in portions, the solvent or the mixture may be stirred while the inorganic oxide filler is being added thereto in portions.

In the step (S1), a stirrer equipped with a stirring blade may be used to stir the solvent and the inorganic oxide filler. In the step (S1) when the stirrer is used, the number of revolutions of the stirring blade may be from 1500 rpm to 6000 rpm, or may be from 2000 rpm to 5000 rpm, or may be from 2500 rpm to 4000 rpm. When the number of revolutions of the stirring blade is within the above-mentioned range, the stirring duration in the step (S1) may be from 10 minutes to 60 minutes, or may be from 15 minutes to 50 minutes, or may be from 20 minutes to 40 minutes.

For instance, in the step (S2), the binding material is added to the dispersion, followed by mixing the dispersion and the binding material and stirring, and thereby the slurry may be obtained. In the step (S2), the binding material required for slurry preparation may be added all at once to the dispersion and stirred, or may be added in two or more portions to the dispersion or to the mixed liquid while the latter is being stirred.

For instance, as illustrated in FIG. 2, the step (S2) may include:
a step (S2a) that involves obtaining a first mixed liquid by mixing the dispersion with a part of a total amount of the binding material to be included in the slurry and stirring; and
a step (S2b) that involves mixing the first mixed liquid with a part or whole of a reminder of the total amount of the binding material to be included in the slurry and stirring. The first mixed liquid thus includes the dispersion and the binding material, and the content of the binding material in the first mixed liquid is lower than that in the slurry. The reminder of the total amount of the binding material thus added in the step (S2b) is the amount of the binding material to be included in the slurry from which the amount of the binding material included in the first mixed liquid is subtracted.

When the step (S2b) involves mixing the first mixed liquid with a whole of the reminder of the binding material to be included in the slurry and stirring, the slurry can be obtained in the step (S2b) (which is indicated in FIG. 2 by the solid arrow extending from PREPARE SECOND MIXED LIQUID to PREPARE SLURRY). The step (S2b) may repeat a process of mixing the first mixed liquid with a part of the reminder of the binding material to be included in the slurry and stirring to obtain a second mixed liquid, two or more times (which is indicated in FIG. 2 by the dash-dot arrow extending from PREPARE SECOND MIXED LIQUID back to ADD BINDING MATERIAL). The second mixed liquid includes the first mixed liquid and the binding material, and the content of the binding material in the second mixed liquid is higher than that in the first mixed liquid. In the step (S2b), the process of obtaining the second mixed liquid may be repeated three or more times, or may be repeated four or more times, or may be repeated five or more times, and, usually, it is repeated not more than ten times.

By the step (S2a) and the step (S2b), the entire amount of the binding material to be included in the slurry is eventually added to the dispersion and stirred, and thereby the slurry may be obtained. When the step (S2a) and the step (S2b) are carried out in the step (S2), the binding material can be added in portions by a small amount at a time to the dispersion and the first mixed liquid and stirred, and, as a result, the occurrence of lumps in the slurry can be reduced.

In the step (S2), a stirrer equipped with a stirring blade may be used to stir the dispersion and the binding material. In the step (S2) when the stirrer is used, the number of revolutions of the stirring blade may be from 1500 rpm to 8000 rpm, for example, or may be from 2000 rpm to 7000 rpm, or may be from 3000 rpm to 6000 rpm.

At the time of mixing the dispersion or the first mixed liquid with the binding material, in order to facilitate the dissolution of the binding material, the dispersion or the first mixed liquid is preferably warmed. When warming, the temperature of the dispersion or the first mixed liquid may be from 35° ° C. to 60° C., for example, or may be from 40° C. to 55° C. At the time of warming the dispersion and the first mixed liquid, the temperature of the liquid may be adjusted to the above-mentioned range by heating with a heating apparatus such as a heater. Alternatively, without using a heating apparatus, the dispersion and the first mixed liquid may be stirred rapidly for adjusting the temperature of the liquid to the above-mentioned range. In the case when the temperature of the liquid is raised by rapid stirring, the number of revolutions of the stirring blade of the stirrer may be set to the above-mentioned range, for example.

When the step (S2a) and the step (S2b) are carried out with the use of a stirrer, the number of revolutions of the stirring blade and the stirring duration may be the same or different between these two steps. In the step (S2b), when the process of obtaining the second mixed liquid is repeated two or more times, the number of revolutions of the stirring blade and the stirring duration may be the same or different between the processes.

As for the stirring in the step (S2a), and as for the first to (n−1)-th stirrings in the case when the obtaining the second mixed liquid in the step (S2b) is repeated n times (n denotes an integer of two or more), the number of revolutions of the stirring blade may be, independently, from 1500 rpm to 6000 rpm, or may be from 2000 rpm to 5000 rpm, or may be from 2500 rpm to 4000 rpm, and the stirring duration may be, independently, from 1 minute to 60 minutes, or may be from 3 minutes to 30 minutes, or may be from 5 minutes to 10 minutes.

As for the stirring when only one stirring is carried out in the step (S2b), and as for the n-th stirring when the process of obtaining the second mixed liquid in the step (S2b) is repeated n times (n denotes an integer of two or more), the number of revolutions for the stirring may be from 1500 rpm to 6000 rpm, or may be from 2000 rpm to 5000 rpm, or may be from 2500 rpm to 4000 rpm, and the stirring duration may be from 30 minutes to 240 minutes, or may be from 60 minutes to 180 minutes, or may be from 100 minutes to 150 minutes. As for the stirring when only one stirring is carried out in the step (S2b), and as for the n-th stirring when the process of obtaining the second mixed liquid in the step (S2b) is repeated n times (n denotes an integer of two or more), the stirring duration may be longer than the stirring duration of the previous stirring(s).

### (Method of Producing Non-Aqueous Electrolyte Secondary Battery)

The slurry obtained by the above-mentioned method of producing a slurry can be used in a method of producing a non-aqueous electrolyte secondary battery. A non-aqueous electrolyte secondary battery usually comprises an electrode assembly that includes a positive electrode plate, a negative electrode plate, and a separator, as well as an electrolyte, and the non-aqueous electrolyte secondary battery may further comprise a case for accommodating the electrode assembly and the electrolyte. The positive electrode plate has a positive electrode active material layer on a positive electrode current collector. The negative electrode plate has a negative electrode active material layer on a negative electrode current collector. The positive electrode plate and/or the negative electrode plate may have a protective layer. The electrode assembly has a structure in which the separator is interposed between the positive electrode active material layer of the positive electrode plate and the negative electrode active material layer of the negative electrode plate. The electrode assembly may be a wound-type electrode assembly, or may be a stack-type electrode assembly.

In the method of producing a non-aqueous electrolyte secondary battery, in the step of producing the positive electrode plate and/or in the step of producing the negative electrode plate, for example, the above-mentioned slurry can be used. The step of producing the positive electrode plate may include applying the slurry on the positive electrode current collector or on the positive electrode active material layer and drying. The slurry may be applied on the positive electrode current collector, in a position adjacent to the positive electrode active material layer formed on the positive electrode current collector in a plan view of the positive electrode plate. Alternatively, the slurry may be applied on the positive electrode active material layer formed on the positive electrode current collector. The step of producing the negative electrode plate may include applying the slurry on the negative electrode current collector or on the negative electrode active material layer and drying. The slurry may be applied on the negative electrode current collector, in a position adjacent to the negative electrode active material layer formed on the negative electrode current collector in a plan view of the negative electrode plate. Alternatively, the slurry may be applied on the negative electrode active material layer formed on the negative electrode current collector.

The positive electrode current collector is an aluminum foil, or a metal foil made of an aluminum material such as aluminum alloy, for example. The positive electrode active material layer includes a positive electrode active material, and it may further include either a binder or a conductive aid, or both. Examples of the positive electrode active material include a lithium transition metal oxide of layered type, spinel type, or the like (such as LiNiCoMnO₂, LiNiO₂, LiCoO₂, LiFeO₂, LiMn₂O₄, LiNi_{0.5}Mn_{1.5}O₄, LiCrMnO₄, LiFePO₄, and LiNi_{1/3}Co_{1/3}Mn_{1/3}O₂, for example). Examples of the binder include one or more types selected from the group consisting of styrene-butadiene rubber (SBR), polyvinylidene difluoride (PVdF), and polytetrafluoroethylene (PTFE). Examples of the conductive aid include a carbon material. Examples of the carbon material include one or more types selected from the group consisting of fibrous carbon, carbon black (such as acetylene black, Ketjenblack), coke, and activated carbon. Examples of the fibrous carbon include carbon nanotubes (CNTs). The CNTs may be single-walled carbon nanotubes (SWCNTs), or may be multi-walled carbon nanotubes such as double-walled carbon tubes (DWCNTs).

The negative electrode current collector is a metal foil made of a copper material such as copper and copper alloy, for example. The negative electrode active material layer includes a negative electrode active material, and it may further include either a binding material or a conductive aid, or both. Examples of the negative electrode active material include a carbon-based active material that includes a carbon (C) atom, such as graphite; and a metal-based active material that includes a metallic element such as an elemental metal or a metal oxide including an element selected from the group consisting of silicon (Si), tin (Sn), antimony (Sb), bismuth (Bi), titanium (Ti), and germanium (Ge). Examples of the binding material include a cellulose-based binding material such as carboxymethylcellulose (CMC), styrene-butadiene rubber (SBR), and the like. Examples of the conductive aid include a carbon material such as fibrous carbon, carbon black (such as acetylene black, Ketjenblack, for example), coke, and activated carbon. Examples of the fibrous carbon include those described above.

### EXAMPLES

In the following, the present disclosure will be described in further detail by way of Examples and Comparative Example.

### [Preparation of Raw Material of Slurry]

As raw material for preparing the slurry of Examples and Comparative Example, N-methyl-2-pyrrolidone (NMP) was prepared as a solvent, an alumina (Al₂O₃) filler was prepared as an inorganic oxide filler, and polyvinylidene difluoride (PVdF) powder was prepared as a binding material.

### Examples 1 to 4

The slurry of Examples was prepared with the use of a stirrer, in the order specified in FIG. 2. As shown in the step (S1) in FIG. 2, the solvent and the inorganic oxide filler were stirred for 30 minutes at a number of revolutions of the stirring blade of 3000 rpm, and thereby a dispersion was obtained. As shown in the step (S2a) in FIG. 2, the binding material was added to the dispersion, and stirred for 5 minutes at a number of revolutions of the stirring blade of 3000 rpm, and thereby a first mixed liquid was obtained. The binding material was further added to the resulting first mixed liquid and stirred for 5 minutes at a number of revolutions of the stirring blade of 3000 rpm; with this process defined as a single set, a total of four sets were carried out successively (the first to fourth stirrings in the step (S2b) in FIG. 2). Subsequently, the binding material was further added and stirred for 120 minutes at the number of revolutions specified in Table 1 (the last (fifth) stirring in the step (S2b) in FIG. 2), and a slurry having the solid content and the temperature specified in Table 1 was obtained.

The temperature of the slurry is its temperature immediately after preparation. The total stirring duration in the entire procedure was 170 minutes.

### Comparative Example 1

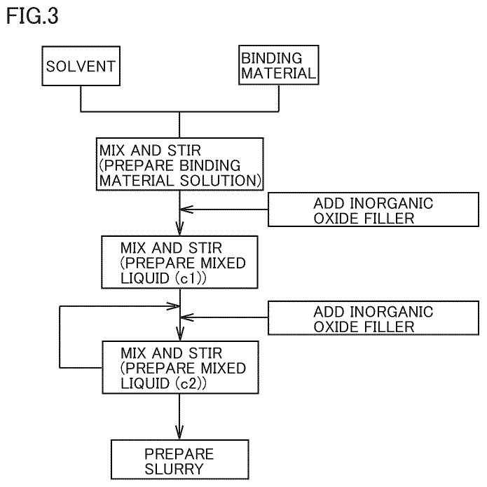

The slurry of Comparative Example was prepared with the use of a stirrer, in the order specified in FIG. 3. FIG. 3 is a flowchart illustrating the method of producing the slurry of Comparative Example. As shown in FIG. 3, while being warmed to a temperature of 60° C., the solvent and the binding material were stirred for 60 minutes at a number of revolutions of the stirring blade of 3000 rpm, and thereby a binding material solution was obtained. The inorganic oxide filler was added to the resulting binding material solution and stirred for 5 minutes at a number of revolutions of the stirring blade of 6000 rpm, and thereby a mixed liquid (c1) was obtained. The inorganic oxide filler was added to the resulting mixed liquid (c1) and stirred for 5 minutes at a number of revolutions of the stirring blade of 6000 rpm; with this process defined as a single set, a total of four sets were carried out successively (which is indicated in FIG. 3 by the arrow extending from PREPARE MIXED LIQUID (c2) back to ADD INORGANIC OXIDE FILLER). Subsequently, the inorganic oxide filler was further added and stirred for 120 minutes at a number of revolutions of the stirring blade of 6000 rpm, and thereby a slurry having the solid content specified in Table 1 was obtained. The total stirring duration in the entire procedure was 200 minutes.

### [Measurement of Viscosity of Slurry]

The container containing the slurry was placed on the stage of a viscometer (a spiral viscometer, manufactured by Malcom Co., Ltd.). The number of revolutions of the rotor of the viscometer was set at 40 rpm, and the rotor was immersed in the slurry to a predetermined liquid level. After the rotor was immersed in the slurry, the maximum value displayed on the viscometer (the peak value) was read, which was regarded as the viscosity [mPa·s]. After the viscosity measurement, the measurement temperature of the viscometer was measured, which was 25° ° C. Results are shown in Table 1.

### [Evaluation of Lumps]

A polyethylene terephthalate (PET) film was placed on a glass plate, and on this PET film, the slurry was applied with an applicator that was designed to achieve a coating thickness of 125 μm, to form a coating film. The glass plate on which the coating film was formed was placed in a drying furnace and dried for 10 minutes at a temperature of 120° ° C. to form a protective layer, and the occurrence of lumps was checked. Using the lumps in Comparative Example 1 as a reference, the size of lumps and the number of lumps in each Example were evaluated to see if they were comparable to the size of lumps and the number of lumps in Comparative Example 1. Results are shown in Table 1.

TABLE 1

| | | | | | Comp. |
|---|---|---|---|---|---|
| | Ex. 1 | Ex. 2 | Ex. 3 | Ex. 4 | Ex. 1 |
| Slurry | | | | | |
| Order of preparation | FIG. 2 | FIG. 2 | FIG. 2 | FIG. 2 | FIG. 3 |
| Solid content [%] | 25 | 15 | 25 | 15 | 25 |
| Viscosity [mPa · s] | 980 | 1050 | 1120 | 1180 | 920 |
| Temperature [° C.] | 55 | 50 | 45 | 40 | — |
| Last stirring in step (S2b) | | | | | |
| Number of revolutions of | 6000 | 6000 | 2000 | 2000 | — |
| stirring blade [rpm] | | | | | |
| Total stirring duration [minutes] | 120 | 120 | 120 | 120 | — |
| Total stirring duration | 170 | 170 | 170 | 170 | 200 |
| in entire procedure [minutes] | | | | | |
| Evaluation of lumps | Comparable | Comparable | Comparable | Comparable | Reference |
| | to reference | to reference | to reference | to reference | |

Although the embodiments of the present disclosure have been described, the embodiments disclosed herein are illustrative and non-restrictive in any respect. The scope of the present disclosure is defined by the terms of the claims, and is intended to encompass any modifications within the meaning and the scope equivalent to the terms of the claims.

What is claimed is:

1. A method of producing a slurry intended for forming a protective layer for a non-aqueous electrolyte secondary battery, wherein
the slurry includes an inorganic oxide filler, a binding material, and a solvent, and
the method comprises:
a step (S1) that involves obtaining a dispersion by dispersing the inorganic oxide filler in the solvent; and
a step (S2) that involves mixing the dispersion with the binding material and stirring.

2. The method of producing a slurry according to claim 1, wherein
the step (S2) includes:
a step (S2a) that involves obtaining a first mixed liquid by mixing the dispersion with a part of a total amount of the binding material to be included in the slurry and stirring; and
a step (S2b) that involves mixing the first mixed liquid with a part or whole of a reminder of the total amount of the binding material and stirring.

3. The method of producing a slurry according to claim 2, wherein the step (S2b) repeats a process of mixing the first mixed liquid with a part of the reminder of the total amount of the binding material and stirring to obtain a second mixed liquid, two or more times.

4. The method of producing a slurry according to claim 2, wherein
the step (S2) is carried out using a stirrer equipped with a stirring blade, and
a number of revolutions of the stirring blade in the step (S2) is from 1500 rpm to 8000 rpm.

5. The method of producing a slurry according to claim 1, wherein the inorganic oxide filler is one or more types selected from the group consisting of alumina filler, magnesia filler, silica filler, zirconia filler, and titania filler.

6. The method of producing a slurry according to claim 1, wherein the binding material is powder of a polymer compound.

7. The method of producing a slurry according to claim 1, wherein the binding material is polyvinylidene difluoride (PVdF).

8. The method of producing a slurry according to claim 1, wherein a viscosity of the slurry at a temperature from 10 to 40° C. is from 500 mPa·s to 1500 mPa·s.

9. The method of producing a slurry according to claim 1, wherein a solid content of the slurry is from 10 weight % to 40 weight %.

10. The method of producing a slurry according to claim 1, wherein the slurry further includes a conductive agent.

11. The method of producing a slurry according to claim 1, wherein the solvent is a non-aqueous solvent.
